(19) United States
(12) Patent Application Publication
(10) Pub. No.: US 2024/0088532 A1
(43) Pub. Date: Mar. 14, 2024

(54) Welding member, Cylindrical Battery and Electric Apparatus

(71) Applicant: JIANGSU ZENERGY BATTERY TECHNOLOGIES CO., LTD., Jiangsu (CN)

(72) Inventor: Hongjiang YU, Jiangsu (CN)

(21) Appl. No.: 18/243,662

(22) Filed: Sep. 8, 2023

(30) Foreign Application Priority Data
Sep. 9, 2022 (CN) 202222395355.8

(51) Int. Cl. H01M 50/566; H01M 50/536; H01M 50/559

(52) U.S. Cl. CPC H01M 50/566; H01M 50/536; H01M 50/559

(57) ABSTRACT

Disclosed are a welding member, a cylindrical battery and an electric apparatus which relate to the technical field of batteries. The welding member includes a main body and a first protrusion formed by outwards protruding from the main body along a thickness direction of the main body, and the first protrusion is configured to abut against an end surface of a tab of the battery. The welding member provided by the disclosure is configured to weld the tab, and by adopting the welding member provided by the disclosure, the tab is directly welded together with an inner wall of a housing, a top cover, or the like without pretreatment such as die cutting on the tab, and a current collecting member does not need to be arranged, so that a space utilization rate inside the housing is improved, and a volume energy density of the battery is improved.

### CROSS-REFERENCE TO RELATED APPLICATION

The disclosure claims priority to and the benefit of Chinese Patent Application No. 202222395355.8, filed to the China National Intellectual Property Administration (CHIPA) on 9 Sep. 2022, which is hereby incorporated by reference in its entirety.

### TECHNICAL FIELD

The disclosure relates to the technical field of batteries, and in particularly to a welding member, a cylindrical battery and an electric apparatus.

### BACKGROUND

Under normal conditions, a housing of a cylindrical battery is used as a negative electrode. However, the welding between a negative tab and an inner wall of the housing or a negative top cover often has the problem of difficulty in welding process.

In addition, the negative tab is welded with the inner wall of the housing or the negative top cover by a negative current collector plate, a welding process is still complex, and the negative current collector plate is welded with the top cover by folding or the negative current collector plate is welded with the inner wall of the housing by a vertical edge, which occupies a certain internal space of the housing and reduces a volume energy density of a cell.

### SUMMARY

The disclosure aims to provide a welding member for the defects in the related art, so as to solve the problem of difficulty in tab welding.

In order to achieve the above objective, the disclosure adopts the following technical solutions:

Some embodiments of the disclosure provide a welding member, including a main body and a first protrusion formed by outwards protruding from the main body along a thickness direction of the main body, and the first protrusion is configured to abut against an end surface of a tab of a battery.

In some embodiments, a second protrusion is formed by outwards protruding from one end surface of the main body away from the first protrusion, and the second protrusion and the first protrusion are arranged in a staggered manner.

In some embodiments, the main body is provided with a through hole along the thickness direction of the main body, and the through hole is located in the middle of the main body.

In some embodiments, the material of the welding member is any one of tin, lead, cadmium, antimony, indium, or bismuth.

In some embodiments, the melting point of the welding member is less than or equal to 232° C.

Some other embodiments of the disclosure further aims to provide a cylindrical battery, including a housing, a cell, a top cover and the above welding member. The housing is hollow inside to form an accommodating cavity for accommodating the cell. The cell is arranged in the accommodating cavity, and a first tab and a second tab with opposite polarities are respectively led out from both ends of the cell. The top cover is arranged at an opening of the housing, and the top cover is connected to the housing in a sealing manner. The welding member is arranged between the top cover and the first tab. The welding member has a first state and a second state, when in the first state, the welding member abuts against the first tab and limits a position of the cell; and when in the second state, the welding member is respectively electrically connected to the first tab and the top cover.

In some embodiments, the cylindrical battery further includes a electrode post and a current collecting member. The current collecting member is electrically connected to the second tab, and one end of the electrode post penetrates through the housing and is connected to the current collecting member.

In some embodiments, a first insulating part is arranged between the electrode post and the housing, and the first insulating part includes a first base, a second base and a third base. The first base, the second base and the third base are enclosed to form an I-shaped structure with a circular snapping groove, and in an axis direction of the electrode post, the second base is configured between the electrode post and the housing for sealing a gap between the electrode post and the housing.

In some embodiments, the cylindrical battery further includes a second insulating part. The second insulating part includes an insulating portion and an extension portion formed by outwards protruding from the insulating portion. The insulating portion is arranged between the current collecting member and the housing, and the extension portion is arranged between the cell and the housing.

Still some other embodiments of the disclosure further aims to provide an electric apparatus, including the above cylindrical battery.

The disclosure has the beneficial effects that: the welding member includes the main body and the first protrusion formed by outwards protruding from the main body along the thickness direction of the main body, the first protrusion is configured to abut against the end surface of the tab of the battery. The welding member provided by the disclosure is configured to weld the tab, and by adopting the welding member provided by the disclosure, the tab is directly welded together with an inner wall of the housing, the top cover, or the like without pretreatment such as die cutting on the tab, and the current collecting member does not need to be arranged, so that a space utilization rate inside of the housing is improved, and a volume energy density of the battery is improved.

### BRIEF DESCRIPTION OF THE DRAWINGS

The features, advantages, and technical effects of embodiments of the disclosure will be described below with reference to the accompanying drawings.

FIG. 1 is a first schematic structural diagram of a cylindrical battery according to an embodiment of the disclosure.

FIG. 2 is a second schematic structural diagram of a cylindrical battery according to an embodiment of the disclosure.

FIG. 3 is a schematic structural diagram of a first insulating part according to an embodiment of the disclosure.

FIG. 4 is a schematic structural diagram of a cell according to an embodiment of the disclosure.

Herein, reference signs are as follows:
1, main body; 11, first protrusion; 12, second protrusion; 13, through hole; 2, housing; 3, cell; 31, first tab; 32, second tab; 4, top cover; 5, electrode post; 6, current collecting member; 7, first insulating part; 71, first base; 72, second base; 73, third base; 8, second insulating part; 81, insulating portion; 82, extension portion.

### DETAILED DESCRIPTION OF THE EMBODIMENTS

Certain terms are used, for example, in the description and claims to refer to particular components. Those skilled in the art should understand that a hardware manufacturer may use different terms to refer to the same component. The specification and claims do not use the difference in name as a way to distinguish components, but use the difference in function of components as a criterion for distinguishing. As mentioned throughout the specification and claims, “comprising” is an open term, so it should be interpreted as “including but not limited to”. “Approximately” means that within an acceptable error range, those skilled in the art can solve technical problems within a certain error range and basically achieve technical effects.

In the description of the disclosure, it should be understood that that the orientations or positional relationships indicated by the terms “upper”, “down”, “front”, “rear”, “left”, “right”, “horizontal”, etc. are based on the orientations or positional relationships shown in the drawings, and are only for the convenience of describing the disclosure and simplifying the description. The description does not indicate or imply that the apparatus or element referred to must have a specific orientation, be constructed and operated in a specific orientation, and therefore cannot be construed as limiting the disclosure.

In the description of the disclosure, a battery means a single physical module including one or more battery cells to provide a higher voltage and capacity. For example, the battery mentioned in the disclosure includes a battery module or a battery pack, etc. The battery generally includes a box body for packaging one or more battery cells. The box body prevents liquid or other foreign objects from affecting the charging or discharging of the battery cells.

In the description of the disclosure, unless otherwise clearly specified and limited, the terms “first”, “second” and “third” are used for descriptive purposes only, and cannot be understood as indicating or implying relative importance. The term “a plurality of” refers to two or more than two. Unless otherwise specified and stated, the terms “connection”, “fixation” and other terms shall be understood in a broad sense. For example, the “connection” may be a fixed connection, or a detachable connection, or an integrated connection, or an electric connection; and the “connection” may be a direct connection or an indirect connection through an intermediary. The specific meaning of the above-mentioned terminology in the disclosure may be understood by those of ordinary skill in the art in specific circumstances.

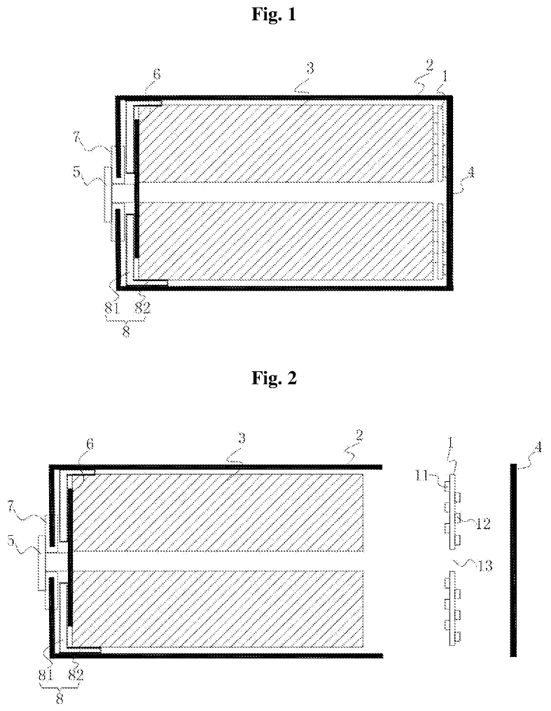

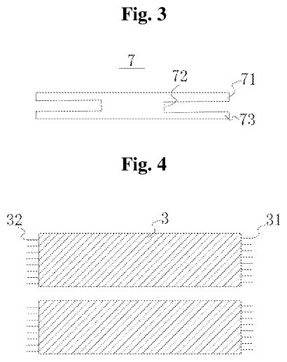

The disclosure is further described in detail below in combination with the FIGS. 1-4, but shall not be regarded as a limitation of the disclosure.

As shown in FIGS. 1-2, an embodiment provides a cylindrical battery, which includes a housing, a cell 3 and an electrolyte.

In the embodiment, a first tab 31 and a second tab 32 with opposite polarities are respectively led out from both ends of the cell 3. The first tab 31 is a positive tab or a negative tab, and correspondingly, the second tab 32 is the negative tab or the positive tab.

The cell 3 is formed by winding a positive electrode plate, a negative electrode plate and a separator. The battery runs mainly relying on the movement of metal ions between the positive electrode plate and the negative electrode plate. The positive electrode plate includes a positive current collector and a positive active material layer. The positive active material layer is coated on at least one surface of the positive current collector. A current collector not coated with the positive active material layer protrudes from a current collector coated with the positive active material layer. The current collector not coated with the positive active material layer is used as the positive tab. Taking a lithium-ion battery as an example, the material of the positive current collector is aluminum, and the positive active material is lithium cobaltate, lithium iron phosphate, ternary lithium or lithium manganate, etc. The negative electrode plate includes a negative current collector and a negative active material layer. The negative active material layer is coated on a surface of the negative current collector. A current collector not coated with the negative active material layer protrudes from a current collector coated with the negative active material layer. The current collector not coated with the negative active material layer is used as the negative tab. The material of the negative current collector is copper, and the negative active material is carbon, or silicon, etc. In order to ensure that no fusing occurs in a case when a large current passes, there are a plurality of positive tabs, and the plurality of positive tabs are stacked together, and there are a plurality of negative tabs, and the plurality of negative tabs are stacked together. The material of the diaphragm is polypropylene (PP) or polyethylene (PE).

In the embodiment, the housing includes a housing 2 and a top cover 4. The housing 2 is hollow inside to form an accommodating cavity for accommodating the cell 3, an end of the housing 2 is provides with an opening, and the top cover 4 covers the opening and is connected to the housing 2 in a sealing manner to form a closed space for accommodating the cell 3, thereby preventing gaseous, liquid or solid substances from circulating between inside and outside the housing to affect the performance of the battery.

In the related art, the negative tab is generally electrically connected by being welded with an inner wall of the housing or the top cover 4 by a negative current collector plate, so as to transport the current generated by an electrochemical reaction of the cell 3 to the electric apparatus. However, this manner still has major disadvantages, for example, the welding process is complex, the welding is difficult, and, whether the negative current collector plate is welded with the top cover 4 by folding or the negative current collector plate is welded with the inner wall of the housing by a vertical edge, the two connection manners occupy an internal space of the housing 2 and then reduce a volume energy density of the cell 3.

Based on this, a welding member is provided for welding the tab with the top cover 4 or the inner wall of the housing. In the embodiment, the welding member is arranged between the first tab 31 and the top cover 4 as solder. During heating outside the battery, the heat is conducted to the welding member by the top cover 4 or the housing 2, so as to promote the melting of the welding member, thereby welding the first tab 31 with the top cover 4 together.

As shown in FIG. 2, considering that after the end surface of the first tab 31 is flattened, the end surface of the first tab 31 still has a certain roughness, and the surface of the welding member also has a certain roughness, so that a contact between the welding member and the end surface of the first tab 31 is not close enough, thereby affecting the final welding effect. Therefore, the welding member provided in the embodiment includes a main body 1 and a first protrusion 11 formed by outwards protruding from the main body 1 along a thickness direction of the main body. The first protrusion 11 is configured to being in contact with the first tab 31. When the welding member is pressed on the end surface of the first tab 31, the first protrusion 11 located at one end of the welding member is pressed into the first tab 31, so that the contact between the welding member and the first tab 31 is closer. When the welding member is melted, there are more contact points for an electrical connection between the first tab 31 and the top cover 4, thereby improving the welding effect of the first tab 31 and the top cover 4.

As shown in FIG. 2, in the welding member provided in the embodiment, a second protrusion 12 is formed by outwards protruding from one end surface of the main body 1 away from the first protrusion 11, and the second protrusion 12 and the first protrusion 11 are arranged in a staggered manner. By adopting the structural design, the welding member and the top cover 4 are more tightly attached. When the welding member is melted and the first tab 31 is electrically connected to the top cover 4 by the welding member, so that the contact points for the electrical connection between the first tab 31 and the top cover 4 are increased.

In an embodiment, the main body 1 is provided with a through hole 13 along the thickness direction of the main body 1, and the through hole 13 is located in the middle of the main body 1. More specifically, after the cell 3 is formed by winding the positive electrode plate, the negative electrode plate and the separator, a hollow hole is formed in the middle of the cell 3, and the through hole 13 located on the main body 1 and the hollow hole in the middle of the cell 3 are coaxially arranged. By adopting the structural design, the electrolyte is conveniently injected into the cell 3 by the through hole 13, thereby improving the injection efficiency.

Considering that the melting point of tin is 231.9° C., that is, the tin metal has the advantages that the melting point is low, the welding process is convenient to operate, the solder wets easily on the surface of the soldered metal, the oxidation resistance is strong, etc. In the embodiment, the welding member is made of tin metal. It is to be noted that the welding member is also made of alloy formed by any one or more combinations of lead, cadmium, antimony, indium, and bismuth.

More specifically, during the production and assembly process of the battery, the welding member has two states, respectively, a first state and a second state, the first state is a state before the welding member is not melted (as shown in FIG. 2), and when in the first state, the welding member abuts against the first tab 31 and limits a position of the cell 3. The second state is a state of the welding member after heating and melting, and when in the second state, the first tab 31 is connected to the cover 4 by the welding member, so that the electric energy generated by the chemical reaction of the cell 3 is conducted to the external electric apparatus through the first tab 31 and the top cover 4 in sequence.

In the embodiment, the cylindrical battery further includes an electrode post 5 and a current collecting member 6. The current collecting member 6 is electrically connected to the second tab 32, and one end of the electrode post 5 penetrates through the housing 2 and is connected to the current collecting member 6. More specifically, in the embodiment, the electrode post 5 is a T-shaped structure, one end of the electrode post 5 penetrates through the housing 2 and abuts against an end surface of the current collecting member 6, and the other end of the electrode post 5 is connected to an end surface of the housing 2 in a snapping manner.

In the embodiment, a first insulating part 7 is arranged between the electrode post 5 and the housing 2, and the first insulating part 7 includes a first base 71, a second base 72 and a third base 73. The first base 71, the second base 72 and the third base 73 are enclosed to form an I-shaped structure with a circular snapping groove, and in an axis direction of the electrode post 5, the second base 72 is configured between the electrode post 5 and the housing 2 for sealing a gap between the electrode post 5 and the housing 2. By adopting the structural design, the first insulating part 7 is sleeved on the housing 2 to avoid the risk that the first insulating part 7 falls into the housing 2.

More specifically, the middle of the second base 72 is provided with a through hole, and the electrode post 5 is partially inserted into the through hole, and there is an interference fit relationship between the electrode post 5 and the second base 72.

In the embodiment, the cylindrical battery further includes a second insulating part 8. The second insulating part 8 includes an insulating portion 81 and an extension portion 82 formed by outwards protruding from the insulating portion 81. The insulating portion 81 is arranged between the current collecting member 6 and the housing 2, and the extension portion 82 is arranged between the cell 3 and the housing 2. By adopting the structural design, the risk of a short circuit of the battery caused by the contact between the current collecting member 6 and the housing 2 is avoided, and the cell 3 is also fixed to prevent the cell 3 from moving in the housing 2.

The embodiments further provide an electric apparatus, including the above cylindrical battery. The electric apparatus is a vehicle, a cell phone, a portable device, a laptop, a ship, a spacecraft, an electric toy, a power tool, etc. The vehicle is a fuel vehicle, a gas vehicle or a new energy vehicle, and the new energy vehicle is a pure electric vehicle, a hybrid vehicle, a range-extended electric vehicle, etc. The spacecraft includes an aircraft, a rocket, a space shuttle, a spaceship, etc. The electric toy includes a stationary or mobile electric toy, such as a game machine, an electric car toy, an electric ship toy, an electric airplane toy, etc. The electric tool includes a metal cutting electric tool, a grinding electric tool, an assembly electric tool, and a railway electric tool, such as an electric drill, an electric grinder, an electric wrench, an electric screwdriver, an electric hammer, an impact drill, a concrete vibrator and plane, etc. No specific limitations are made to the above electric apparatus in the embodiments of the disclosure.

The embodiments further provide a method for manufacturing a cylindrical battery, which includes the following steps.

At S1, winding a positive electrode plate, a negative electrode plate and a separator to form a cell 3.

At S2, flattening a second tab 32.

At S3, welding a current collecting member 6 and a flattening surface of the second tab 32.

At S4, placing the cell 3 into a housing 2.

At S5, connecting the current collecting member 6 to a electrode post 5 by spot backing welding (resistance welding).

At S6, adding a welding member between a first tab 31 and a top cover 4, and making the top cover 4 cover an opening of the housing 2.

At S7, welding and sealing the housing 2 and an end surface of the top cover 4.

At S8, heating the bottom of the top cover 4 to melt the welding member, and welding the first tab 31 and the top cover 4.

In S8, a heating manner includes direct heat source heating, laser heating, and electromagnetic heating.

In addition, it should be understood that although the specification is described according to the embodiments, not each embodiment contains only an independent technical solution. The description of the specification is only for the sake of clarity, those skilled in the art should use the specification as a whole, and the technical solutions in the various embodiments may be appropriately combined to form other embodiments that can be understood by those skilled in the art.

According to the disclosure and teaching of the above specification, those skilled in the art to which the disclosure pertains can also change and modify the above embodiments. Therefore, the disclosure is not limited to the above specific embodiments, and any obvious improvement, substitution or modification made by those skilled in the art on the basis of the disclosure shall fall within the scope of protection of the disclosure. In addition, although some specific terms are used in the specification, these terms are only for convenience of description and do not constitute any limitation to the disclosure.

What is claimed is:

1. A welding member, comprising a main body and a first protrusion formed by outwards protruding from the main body along a thickness direction of the main body, and the first protrusion is configured to abut against an end surface of a tab of a battery.

2. The welding member according to claim 1, wherein a second protrusion is formed by outwards protruding from an end surface of the main body away from the first protrusion.

3. The welding member according to claim 2, wherein the second protrusion and the first protrusion are arranged in a staggered manner.

4. The welding member according to claim 1, wherein the main body is provided with a through hole along the thickness direction of the main body, and the through hole is located in the middle of the main body.

5. The welding member according to claim 1, wherein the material of the welding member is any one of tin, lead, cadmium, antimony, indium, or bismuth.

6. The welding member according to claim 1, wherein the melting point of the welding member is less than or equal to 232° C.

7. A cylindrical battery, comprising:
a housing, the housing is hollow inside to form an accommodating cavity for accommodating a cell;
the cell, the cell is arranged in the accommodating cavity, and a first tab and a second tab with opposite polarities are respectively led out from both ends of the cell;
a top cover, the top cover is arranged at an opening of the housing, and the top cover is connected to the housing in a sealing manner; and
the welding member according to claim 1, the welding member is arranged between the top cover and the first tab, and the welding member has a first state and a second state, when in the first state, the welding member abuts against the first tab and limits a position of the cell; and when in the second state, the welding member is respectively electrically connected to the first tab and the top cover.

8. The cylindrical battery according to claim 7, wherein further comprising an electrode post and a current collecting member, and the current collecting member is electrically connected to the second tab, and one end of the electrode post penetrates through the housing and is connected to the current collecting member.

9. The cylindrical battery according to claim 8, wherein a first insulating part is arranged between the electrode post and the housing, the first insulating part comprises a first base, a second base and a third base, and the first base, the second base and the third base are enclosed to form an I-shaped structure with a circular snapping groove, and in an axis direction of the electrode post, the second base is configured between the electrode post and the housing for sealing a gap between the electrode post and the housing.

10. The cylindrical battery according to claim 8, wherein further comprising a second insulating part, and the second insulating part comprises an insulating portion and an extension portion formed by outwards protruding from the insulating portion, the insulating portion is arranged between the current collecting member and the housing, and the extension portion is arranged between the cell and the housing.

11. The cylindrical battery according to claim 7, wherein a second protrusion is formed by outwards protruding from an end surface of the main body away from the first protrusion, and the second protrusion and the first protrusion are arranged in a staggered manner.

12. The cylindrical battery according to claim 7, wherein the main body is provided with a through hole along the thickness direction of the main body, and the through hole is located in the middle of the main body.

13. The cylindrical battery according to claim 7, wherein the material of the welding member is any one of tin, lead, cadmium, antimony, indium, or bismuth.

14. An electric apparatus, comprising the cylindrical battery according to claim 7.

15. The electric apparatus according to claim 14, wherein the cylindrical battery further comprises an electrode post and a current collecting member, and the current collecting member is electrically connected to the second tab, and one end of the electrode post penetrates through the housing and is connected to the current collecting member.

16. The electric apparatus according to claim 15, wherein a first insulating part is arranged between the electrode post and the housing, the first insulating part comprises a first base, a second base and a third base, and the first base, the second base and the third base are enclosed to form an I-shaped structure with a circular snapping groove, and in an axis direction of the electrode post, the second base is configured between the electrode post and the housing for sealing a gap between the electrode post and the housing.

17. The electric apparatus according to claim 15, wherein the cylindrical battery further comprises a second insulating part, and the second insulating part comprises an insulating portion and an extension portion formed by outwards protruding from the insulating portion, the insulating portion is arranged between the current collecting member and the housing, and the extension portion is arranged between the cell and the housing.

18. The electric apparatus according to claim 14, wherein a second protrusion is formed by outwards protruding from an end surface of the main body away from the first protrusion, and the second protrusion and the first protrusion are arranged in a staggered manner.

19. The electric apparatus according to claim 14, wherein the main body is provided with a through hole along the thickness direction of the main body, and the through hole is located in the middle of the main body.

20. The electric apparatus according to claim 14, wherein the material of the welding member is any one of tin, lead, cadmium, antimony, indium, or bismuth.
